(19) United States
(12) Patent Application Publication
(10) Pub. No.: US 2007/0101250 A1
(43) Pub. Date: May 3, 2007

(54) Data analysis visualization with hyperlink to external content

(75) Inventors: Sebastian Sumpf, Dresden (DE); Lutz Thieme, Dresden (DE)

Correspondence Address: MEYERTONS, HOOD, KIVLIN, KOWERT & GOETZEL (AMD), P.O. BOX 398, AUSTIN, TX, 78767-0398, US

(73) Assignee: Advanced Micro Devices, Inc.

(21) Appl. No.: 11/353,830

(22) Filed: Feb. 14, 2006

(30) Foreign Application Priority Data
Oct. 31, 2005 (DE) 10 2005 052 056.1

(51) Int. Cl. G06F 17/00; G06T 11/20

(52) U.S. Cl. 715/501.1; 345/440

(57) ABSTRACT

A data analysis and visualization system and method are provided where graphics are produced to visualize data to be analyzed and/or an outcome of data analysis. At least some of the produced graphics are embedded in an exportable electronic document, and hyperlink information pointing to external content is associated to graphics embedded in the exportable electronic document and/or graphics to be embedded in the document. For example, the produced data analysis graphics may be embedded in a pdf document, pointing to intranet pages or applications.

### BACKGROUND OF THE INVENTION

1. Field of the Invention

The invention generally relates to data analysis and visualization, and more particularly to systems and methods for graphically visualizing data.

2. Description of the Related Art

Data handling and analysis software is well known in the art. Usually, such software imports raw data and analyzes this data in accordance with predefined or user-specified rules. Generally, the aim of data analysis is to extract useful information and facilitate data conclusions. This may include statistical methods, curve fitting, selecting or discarding certain subsets based on specific criteria, or other techniques. One example of a conventional data analysis system is the R environment which can be regarded as an implementation of the S language developed at Bell Laboratories.

Data analysis results are usually provided in the form of data, and this data is sometimes visualized by the data analysis system itself. For example, a data analysis system could obtain raw data from one or more sources, apply statistical techniques to obtain a spatial or temporal distribution, and then present the result to a user on a screen in the form of an x/y graph. This graph can then be studied by the user, and it may sometimes be useful to print the result on a printer, or store it in an electronic document.

However, the data analysis results are always isolated from other information pertaining to the context in which the data analysis was performed. That is, even when the data analysis system produces well-designed publication-quality plots, this visualization does not include any other information than just the result of data analysis. This is undesirable since understanding data analysis results often requires additional information.

For this reason, data analysis results, even when produced as high-quality graphics, are often supplemented with extra information afterwards. For instance, the data analysis results could be exported to an electronic file which is then imported into other software such as Microsoft Word or Microsoft PowerPoint which is then used to add further information. This may however be cumbersome since it requires a significant amount of extra work in a succeeding step at a time where the data analysis is finished.

### SUMMARY OF THE INVENTION

A data analysis and visualization system, a method for graphically visualizing statistical data, and a computer-readable medium are provided that may allow for easier combining of data analysis results with other relevant information.

In one embodiment, a data analysis and visualization system is provided which comprises a graphics module that is adapted to produce graphics to visualize data to be analyzed and/or visualize an outcome of data analysis. The graphics module is adapted to embed at least some of the graphics in an exportable electronic document. The graphics module is further adapted to associate graphics embedded in the exportable electronic document and/or graphics to be embedded in the exportable electronic document with hyperlink information pointing to electronically accessible content located outside the data analysis and visualization system.

In another embodiment, a method for graphically visualizing statistical data comprises specifying at least one graphical object to be used for visualizing the statistical data, and specifying hyperlink information pointing to external, electronically accessible content. The method further comprises associating the specified hyperlink information with the specified at least one graphical object, and embedding the specified at least one graphical object with associated hyperlink information in an exportable electronic document.

According to a further embodiment, a computer-readable medium stores instructions, that, when executed by a processor, cause the processor to operate a data handling facility to associate a hyperlink with a graphical object and export the associated graphical object and hyperlink in an electronic document. The hyperlink points to content external to the data handling facility and the electronic document.

### BRIEF DESCRIPTION OF THE DRAWINGS

The accompanying drawings are incorporated into and form a part of the specification for the purpose of explaining the principles of the invention. The drawings are not to be construed as limiting the invention to only the illustrated and described examples of how the invention can be made and used. Further features and advantages will become apparent from the following and more particular description of the invention, as illustrated in the accompanying drawings, wherein:

FIG. 1 is a block diagram illustrating a data analysis and visualization system and a data presentation environment according to an embodiment;

FIG. 2 is a flowchart illustrating a data handling and presentation process according to an embodiment;

FIG. 3 is a flowchart illustrating a visualization process according to an embodiment;

FIG. 4A is a box plot trend chart according to an embodiment where the mouse pointer is outside any link sensitive area;

FIG. 4B is a box plot trend chart according to an embodiment where the mouse pointer is moved over a link sensitive area; and

FIG. 4C is a box plot trend chart according to an embodiment where the mouse pointer is moved over another link sensitive area.

### DETAILED DESCRIPTION OF THE INVENTION

The illustrative embodiments of the present invention will be described with reference to the figure drawings wherein like elements and structures are indicated by like reference numbers.

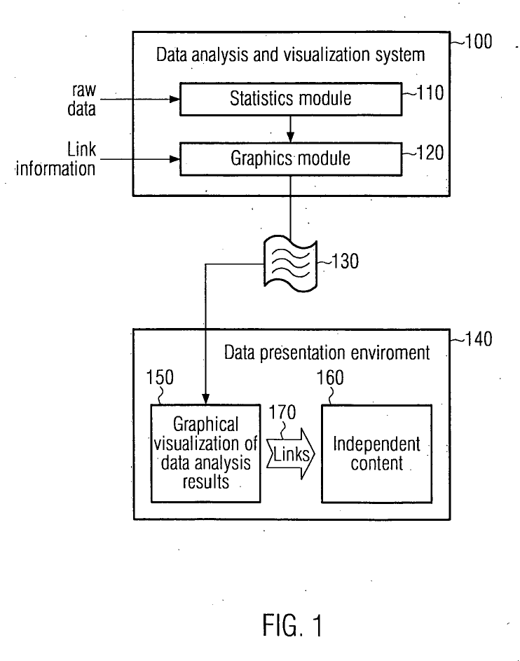

Referring now to the drawings, and in particular to FIG. 1, a system according to an embodiment is depicted. In one part, there is a data analysis and visualization system 100 that has a statistics module 110 and a graphics module 120. The statistics module 110 receives raw data from an external source, and applies statistics methods for data analysis purposes.

In an embodiment, the statistics module 110 performs collection and interpretation of quantitative data and uses probability theory to make investigations and estimations. It may use empirical data expressed in quantitative form, and may be concerned with modelling randomness and uncertainty. Specifically, the statistics module 110 may further perform curve fitting, interpolation and extrapolation, time, space and frequency distribution calculation, correlation and autocorrelation, and other data handling techniques. Further, embodiments exist where the statistics module 110 performs non-statistics techniques in addition to statistics methods. It is noted that further embodiments do solely apply non-statistics techniques.

The outcome of the data analysis in statistics module 110 is provided to the graphics module 120 for visualization purposes. In the embodiment of FIG. 1, the graphics module 120 visualizes the data analysis results by producing graphics and embedding the graphics in an exportable electronic document 130. Thus, it is noted that visualization according to the present embodiment does not require that the graphics are actually presented to a user at that time. Rather, graphics are produced and embedded in an exportable electronic document 130 such that the graphics can be presented some time later.

While the data analysis and visualization system 100 of FIG. 1 is depicted to include both a statistics module 110, and a graphics module 120, it is noted that other embodiments may exist not having a statistics module 110. In this case, the raw data is provided directly to the graphics module 120 so that the data analysis and visualization system 100 then produces graphics to visualize the raw data. In a further embodiment, the raw data may be provided to the graphics module 120 even though there is a statistics module 110 provided in the data analysis and visualization system 110. In this case, the graphics module 120 produces graphics to visualize the data to be analyzed, i.e., the raw data, but not the outcome of data analysis performed by the statistics module 110. In yet another embodiment, the data analysis and visualization system 100 may have the graphics module 120 coupled in a manner so as to be capable to produce graphics to visualize data to be analyzed as well as an outcome of data analysis.

As may be seen from FIG. 1, there is further provided a data presentation environment 140 which may be a computer system having a display to present graphics. The data presentation environment 140 of the present embodiment receives the exportable electronic document 130 from the graphics module 120 of the data analysis and visualization system 100. Based on the received exportable electronic document 130, the data presentation environment 140 then performs a graphical visualization of the graphical objects present in the document. For this purpose, the data presentation environment 140 may contain a module 150 for storing and graphically visualizing the data analysis results received from the data analysis and visualization system 100.

As apparent from FIG. 1, the graphical visualization 150 of data analysis results may be linked to separate, independent content 160 provided within the data presentation environment 140. The independent content 160 is content not generated by the data analysis and visualization system 100. Nevertheless, the graphics within the exportable electronic document 130 and graphically visualized in module 150 are linked to the independent content 160, as illustrated by arrow 170 in FIG. 1.

For instance, the graphical visualization 150 may be a pie chart, and certain areas within the pie chart are linked to content 160. This link may be activated in an embodiment by clicking on the respective pie chart area using a pointing device such as a mouse. Exemplarily assuming that presentation takes place in a windowing environment, the respective independent content may then be shown in a popup window nearby the mouse pointer, in a bottom line of the window, or in an extra window which may be a daughter window or a new window instance. Other embodiments not using pie charts but any other diagram, chart, plot or the like exist as well.

In any of the embodiments, the graphics module 120 of the data analysis and visualization system 100 receives link information from a user or another external data source. Using this link information, the graphics module 120 associates at least some of the produced visualization graphics with hyperlink information pointing to the electronically accessible content 160 located outside the data analysis and visualization system 100.

That is, although the independent content 160 is not located in or provided by the data analysis and visualization system 100, the graphics module 120 of the data analysis and visualization system 100 associates hyperlink information to this content. In other words, although the link information received by the graphics module 120 of the data analysis and visualization system 100 is not used to perform the data analysis but only used later by the data presentation environment 140 at a time where data analysis is completed, it is a task of the graphics module 120 of the data analysis and visualization system 100 to associate respective hyperlink information with graphics which are embedded or to be embedded. The associated and embedded hyperlink information may then be primarily or exclusively used in the data presentation afterwards to provide links 170 from the graphical visualization 150 of data analysis results, to independent content 160.

It is noted that the term “hyperlink” refers to any link in a document to independent content 160. The hyperlink may be a hypertext link or any other cross-referencing pointer. For instance, the hyperlink may include a URI (Uniform Resource Identifier) which may be a URL (Uniform Resource Locator). It is however noted that the embodiments are not restricted to the use of HTML (Hyper Text Mark-up Language) documents to visualize the graphics.

In any embodiment, the independent content 160 may be static content or dynamic content. For instance, the content may be provided by static or dynamic HTML pages, or by internet or intranet applications which are dynamic.

In an embodiment, the exportable electronic document 130 may be a PDF (Portable Document Format) document but other embodiments may use other document formats such as SVG (Scalable Vector Graphics), XML (Extensible Markup Language), HTML or the like. In any case, the document format allows for embedding graphical objects having hyperlink information associated.

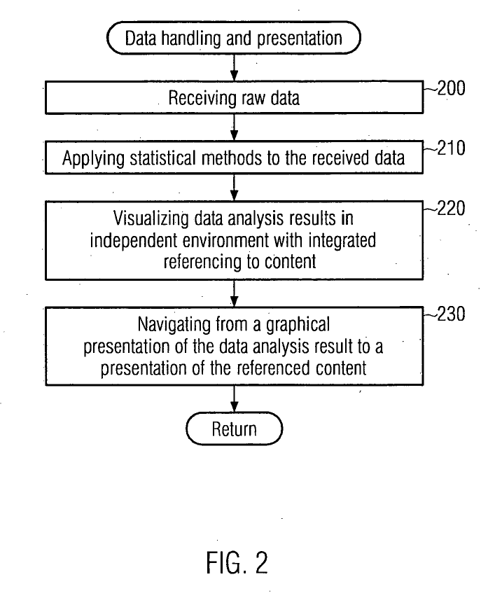

Turning now to FIG. 2, a flow chart is depicted for illustrating data handling and presentation. In step 200, the data analysis and visualization system 100 receives raw data. Step 210 then applies statistical methods to the received raw data. Once the data analysis is performed in step 210, the data analysis results can be visualized in step 220 in an independent environment such as the data presentation environment 140 with integrated referencing by links 170 to content 160. This then allows a user to navigate in step 230 from a graphical presentation of the data analysis results to a presentation of the referenced content, for instance by clicking on a graphic object.

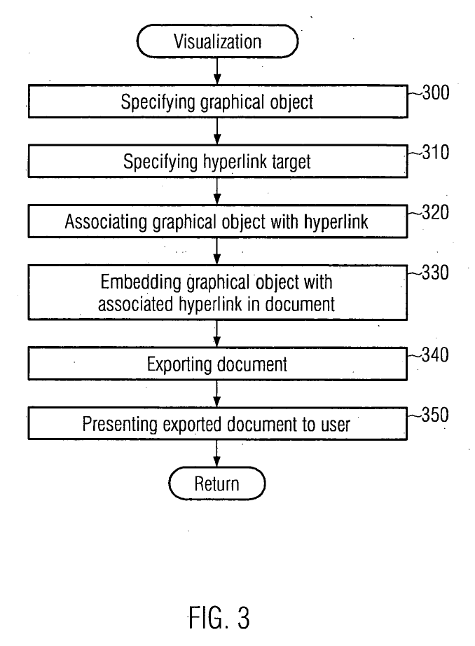

An example of how to perform step 220 is depicted in more detail in the flow chart of FIG. 3. In step 300, the graphics module 120 of the data analysis and visualization system 100 specifies a graphical object to be embedded. Then, a hyperlink target may be specified in step 310 based on link information received by the graphics module 120. The graphical object is then associated with a hyperlink in step 320 and embedded in the document 130 in step 330. Document 130 is then exported in step 340 for immediate or later use by one or more data presentation environments 140. In step 350, the exported electronic document 130 is presented to the user in a manner so as to allow the user to follow a link 170 from a graphical visualization of the data analysis results 150 to independent content 160.

Referring to the flowcharts of FIGS. 2 and 3, it is noted that the flowcharts show various process steps in a specific order, but the embodiments should not be understood to be restricted to this specific order. For instance, the order of steps 300 and 310 may be reversed, or both steps may even be performed simultaneously. In another embodiment, steps 300 and 310 may be merged with step 320 so that the graphical object and the hyperlink target are then actually specified at the time of association of the graphical object with the hyperlink.

It is further noted that the embodiments are not restricted to perform the hyperlink association prior to embedding of the graphical object in the document 130. Rather, embodiments exist where the graphical object is first embedded, and the hyperlink information is then added afterwards.

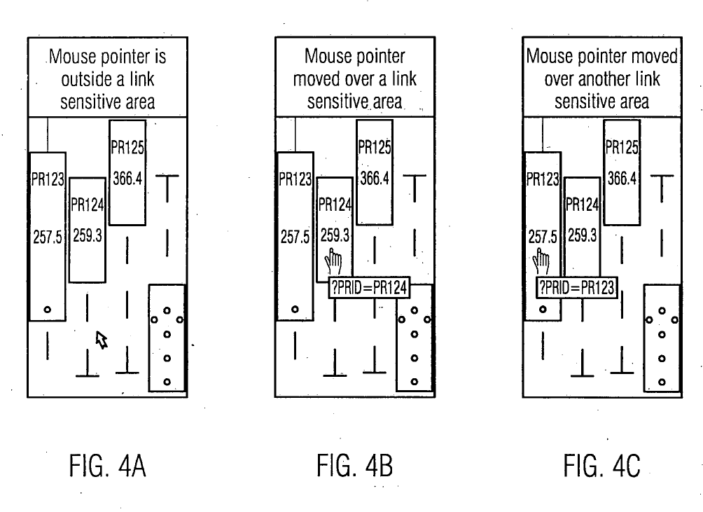

Turning now to FIGS. 4A to 4C, an example of a graphical visualization technique according to the embodiments is depicted. In this example, a box plot trend chart is shown which has link sensitive areas. The box plot trend chart is embedded in a PDF document and includes multiple rectangular boxes which are located side by side. Assuming that the vertical axis of the charts is a time axis, each box indicates a different time period which is greater for large boxes and smaller for small boxes. Further, boxes located above other boxes could indicate later time periods. Further assuming that the box plot trend chart of FIGS. 4A to 4C illustrate product engineering stages in a multiple component manufacturing process, and each box is for a different product component, the chart allows for understanding which component manufacturing stages are temporally aligned with other component stages. It is noted that the location and the vertical size of the boxes may be the result of complex data analysis based on a huge amount of raw data received from manufacturing equipment.

Some or all of the boxes may be hyperlinked to external, independent content provided on intranet pages. Taking for instance FIG. 4A, the mouse pointer is outside a link sensitive area, i.e., a box so that pressing the mouse button will not activate any hyperlink. In FIG. 4B, the mouse pointer is located above the second box which may be related to a product component having a product identifier (PRID) of “PR124”. Thus, clicking on this box will open an intranet page showing data analysis independent content with respect to the component PR124. A similar example is given in FIG. 4C where the first box is used which relates to the product component PR123.

It is noted that FIGS. 4A to 4C illustrate the temporal relationship of various stages in a manufacturing process of multiple product components, but the embodiments are not restricted to this example.

Any of the above described embodiments may be implemented within the data analysis and visualization system 100 using a modified R environment. For instance, the R language can be modified to add a new link argument to the rect( ) command. The rect( ) command produces a rectangle of specified size and the added links argument would then indicate the hyperlink target. For instance,
rect(1,1,2,2,links=“http://www.domain.com”)

would produce an invisible rectangle with link.

rect(2,c(2,6),5,c(4,8),links=c(“http://www.domain.com/
page1.html”,“http://www.domain.com/page2.html”))

would produce two transparent rectangles, each having one link.
rect(2,c(2,6),5,c(4,8),links=c(“http://www.domain.com”, NA))
   would also produce two transparent rectangles each having one link, but the second rectangle would not be drawn.

It is noted that the hyperlink information to be associated with the graphics may be split into hyperlink base data and hyperlink supplement data so that the hyperlink information is formed by concatenating the hyperlink base data and the hyperlink supplement data. For instance, the hyperlink base data may be a base URL such as “http://www.domain.com/page.php”, and the hyperlink supplement data may then provide parameter information such as “?PRID=PR123”. Activating this hyperlink will then result in “http://www.domain.com/page.php?PRID=PR123.”

The graphics module 120 may be adapted to receive the hyperlink base data in a command to open the exportable electronic document for later embedding of one or more graphics and receive the hyperlink supplement data in a command to embed a graphic in the opened exportable electronic command. For instance, the base URL may be an additional argument to the pdf( ) command in a modified R environment while the hyperlink supplement data may be provided using the above-mentioned additional links argument in a modified rect( ) command.

It is noted that the embodiments are not restricted to the use of rectangles. Rather, any other graphical object may be used instead such as triangles, circles, lines, points, free-curve objects, and so on.

When taking the example of generating a PDF document as exportable electronic document 130, the graphics module 120 may be further adapted to create the PDF document in a manner specifically adapted to facilitate inclusion in other electronic documents. For instance, the graphics module 120 may be configured to add only generic font information to document 130. In another embodiment, the graphics module 120 may be configured to not apply any compression mechanism within the exportable electronic document 130.

While the invention has been described with respect to the physical embodiments constructed in accordance therewith, it will be apparent to those skilled in the art that various modifications, variations and improvements of the present invention may be made in the light of the above teachings and within the purview of the appended claims without departing from the spirit and intended scope of the invention. In addition, those areas in which it is believed that those of ordinary skill in the art are familiar, have not been described herein in order to not unnecessarily obscure the invention described herein. Accordingly, it is to be understood that the invention is not to be limited by the specific illustrative embodiments, but only by the scope of the appended claims.

What is claimed is:

1. A data analysis and visualization system comprising:
a graphics module adapted to produce graphics to visualize data to be analyzed and/or visualize an outcome of data analysis,
wherein said graphics module is adapted to embed at least some of said graphics in an exportable electronic document, and
wherein said graphics module is adapted to associate graphics embedded in said exportable electronic document and/or graphics to be embedded in said exportable electronic document with hyperlink information pointing to electronically accessible content located outside said data analysis and visualization system.

2. The data analysis and visualization system of claim 1, wherein said hyperlink information pointing to external content is an URI (Uniform Resource Identifier).

3. The data analysis and visualization system of claim 2, wherein said hyperlink information comprises hyperlink base data and hyperlink supplement data, and said hyperlink information is formed by concatenating said hyperlink base data and said hyperlink supplement data.

4. The data analysis and visualization system of claim 3, wherein said graphics module is adapted to receive said hyperlink base data in a command to open said exportable electronic document for later embedding of one or more graphics, and receive said hyperlink supplement data in a command to embed a graphic in the opened exportable electronic document.

5. The data analysis and visualization system of claim 1, wherein said hyperlink information pointing to external content is hyperlink information pointing to an intranet page or application.

6. The data analysis and visualization system of claim 1, wherein at least one of said graphics associated with hyperlink information is a rectangle.

7. The data analysis and visualization system of claim 1, wherein said exportable electronic document is a pdf document.

8. The data analysis and visualization system of claim 7, wherein said graphics module is adapted to create said pdf document in a manner specifically adapted to facilitate inclusion in other electronic documents.

9. The data analysis and visualization system of claim 1, further comprising:
a statistics module adapted to apply statistical methods to said data to be analyzed,
wherein at least one of said at least some embedded graphics visualize results of applying said statistical methods.

10. A method for graphically visualizing statistical data, comprising:
specifying at least one graphical object to be used for visualizing said statistical data;
specifying hyperlink information pointing to external, electronically accessible content;
associating the specified hyperlink information with the specified at least one graphical object; and
embedding the specified at least one graphical object with associated hyperlink information in an exportable electronic document.

11. The method of claim 10, wherein said hyperlink information pointing to external content is an URI (Uniform Resource Identifier).

12. The method of claim 11, wherein said hyperlink information comprises hyperlink base data and hyperlink supplement data, and the method further comprises:
concatenating said hyperlink base data and said hyperlink supplement data to form said hyperlink information.

13. The method of claim 12, further comprising:
receiving said hyperlink base data in a command to open said exportable electronic document for later embedding of one or more graphics; and
receiving said hyperlink supplement data in a command to embed a graphic in the opened exportable electronic document.

14. The method of claim 10, wherein said hyperlink information pointing to external content is hyperlink information pointing to an intranet page or application.

15. The method of claim 10, wherein said at least one graphical object to be associated with hyperlink information is a rectangle.

16. The method of claim 10, wherein said exportable electronic document is a pdf document.

17. The method of claim 16, further comprising:
creating said pdf document in a manner specifically adapted to facilitate inclusion in other electronic documents.

18. The method of claim 10, further comprising:
applying statistical methods to raw data to generate said statistical data.

19. The method of claim 10, further comprising:
presenting said at least one graphical object to a user to visualize said statistical data.

20. A computer-readable medium storing instructions that, when executed by a processor, cause the processor to operate a data handling facility to associate a hyperlink with a graphical object and export the associated graphical object and hyperlink in an electronic document, said hyperlink pointing to content external to said data handling facility and said electronic document.
